(19) United States
(12) Patent Application Publication
(10) Pub. No.: US 2019/0156511 A1
(43) Pub. Date: May 23, 2019

(54) REGION OF INTEREST IMAGE GENERATING DEVICE

(71) Applicant: Sharp Kabushiki Kaisha, Sakai City, Osaka (JP)

(72) Inventors: Kyohei IKEDA, Sakai City (JP); Tomoyuki YAMAMOTO, Sakai City (JP); Norio ITOH, Sakai City (JP)

(21) Appl. No.: 16/095,002

(22) PCT Filed: Feb. 1, 2017
(86) PCT No.: PCT/JP2017/003635

§ 371 Date: Oct. 19, 2018

(30) Foreign Application Priority Data
Apr. 28, 2016 (JP) 2016-090463

(51) Int. Cl. G06T 7/73

(52) U.S. Cl. CPC G06T 7/73; G06T 2207/30196

(57) ABSTRACT

A problem to be addressed by disclosure is, without using a specific device such as an eye-tracking device, to extract from a bird's-eye image a region of interest of a subject person as a region of interest image as viewed through the eyes of the subject person. Provided is a region of interest image generating device, which extracts, from at least one bird's-eye image, camera parameters, and spatial position information which includes information of the heights of objects in the at least one bird's-eye image, a region of interest in the at least one bird's-eye image as a region of interest image as viewed from a different viewpoint. The region of interest image generating device includes: a viewpoint position deriving unit configured to derive a viewpoint position; a region of interest deriving unit configured to derive the region of interest in the at least one bird's-eye image; a conversion formula deriving unit configured to derive a conversion formula for converting the viewpoint position based on the viewpoint position and the region of interest; an image region of interest deriving unit configured to derive an image region of interest being a region, in the at least one bird's-eye image, that corresponds to the region of interest; and a region of interest image conversion unit configured to generate, based on the conversion formula and the image region of interest, the region of interest image.

### TECHNICAL FIELD

One aspect of disclosure relates to a region of interest image generating device configured to extract a region to be interested in a space reflected in a bird's-eye image as an image as viewed from a real or virtual viewpoint.

### BACKGROUND ART

Recently, there are more opportunities to photograph a wide range of spaces as wide-angle images by using a camera equipped with a wide-angle lens called a whole circumference camera and use the wide-angle images. In particular, a wide-angle image photographed by the whole circumference camera installed on the upper part of a space to be photographed, such as a ceiling, is also called a bird's-eye image. There is a technology for extracting, from the bird's-eye image, an image of a region interested by a person (region of interest) in the bird's-eye image and converting the extracted image to an image as viewed from the eyes of the user.

PTL 1 describes a technology for estimating the position of the eyes of a user based on an image of a camera installed in front of the user, configuring a projection transformation matrix based on relative positions between the display surface of a display placed near the camera and the eyes of the user, and rendering a display image.

In addition, PTL 2 describes a technology for reducing bandwidth usage by delivering a whole-sky image or a cylindrical panoramic image in a low resolution and delivering a part interested by a user by clipping the part from the image with a high image quality.

In addition, in order to estimate a region of interest and convert the region of interest to an image as viewed from the eyes of a user, the line of sight of the user needs to be detected, and generally, an eye-tracking device is used for that purpose. For example, there is an eyeglass-type eye-tracking device, or a camera-type eye-tracking device installed oppositely to the face of the user.

### CITATION LIST

### Patent Literature

PTL 1: JP 2015-8394 A

PTL 2: JP 2014-221645 A

### SUMMARY

### Technical Problem

However, in the line of sight detection by means of the eyeglass-type eye-tracking device, device cost and a burden on a person due to the wearing of the eyeglass become problems. In addition, in the case of the oppositely installed camera-type eye-tracking device, there is also a problem of device cost, and additionally, there is a problem that because the line of sight cannot be detected in a case that eyes are not reflected in the oppositely installed camera, the line of sight can be detected within a limited range, i.e., near a region in front of the photographing device.

One aspect of disclosure has been made in view of the situation described above, and it is an object thereof to extract, from a bird's-eye image, an image as viewed from a person in the bird's-eye image without using an eye-tracking device.

### Solution to Problem

In order to solve the above-described problem, a region of interest image generating device related to one aspect of disclosure is an image generating device that extracts, from at least one bird's-eye image, a region of interest being an interested region in the bird's-eye image as a region of interest image as viewed from a different viewpoint, the image generating device including: a viewpoint position deriving unit configured to derive a viewpoint position based on at least the at least one bird's-eye image, parameters related to an optical device for photographing the bird's-eye image, and spatial position information for indicating a spatial position of an object in the at least one bird's-eye image; a region of interest deriving unit configured to derive the region of interest based on at least the at least one bird's-eye image, the parameters, and the spatial position information; a conversion formula deriving unit configured to derive, based on at least the viewpoint position and the region of interest, a conversion formula for converting a first image, in the at least one bird's-eye image, that corresponds to the region of interest to an image as viewed from the viewpoint position; an image region of interest deriving unit configured to derive, based on at least the at least one bird's-eye image, the parameters, and the region of interest, an image region of interest being a region, in the at least one bird's-eye image, that corresponds to the region of interest; and a region of interest image conversion unit configured to extract a pixel corresponding to the image region of interest from the at least one bird's-eye image based on at least the conversion formula, the at least one bird's-eye image, and the image region of interest, and converts the pixel to the region of interest image.

In addition, the spatial position information includes height information related to a person in the at least one bird's-eye image, and the viewpoint position deriving unit is configured to derive the viewpoint position based on at least the height information related to the person and the at least one bird's-eye image.

In addition, the spatial position information includes height information related to an interested subject in the at least one bird's-eye image, and the region of interest deriving unit is configured to derive the region of interest based on at least the height information related to the subject and the at least one bird's-eye image.

In addition, the subject is a hand of a person.

In addition, the subject is a device handled by a person.

### Advantageous Effects of Invention

The above-described object or other objects, characteristics, and advantages of one aspect of disclosure will be more easily understood by considering the following detailed descriptions about one aspect of disclosure with the accompanying drawings.

### BRIEF DESCRIPTION OF DRAWINGS

FIG. 1 is a block diagram illustrating a configuration example of a region of interest image generating unit included in a region of interest image generating device according to an embodiment of disclosure.

FIG. 2 is a diagram illustrating an example of a photographing form according to the embodiment.

FIG. 3 is a block diagram illustrating a configuration example of the region of interest image generating device.

FIG. 4 is a schematic diagram for describing operations of a viewpoint position deriving unit included in the region of interest image generating device.

FIG. 5 is an image diagram for describing operations of the viewpoint position deriving unit included in the region of interest image generating device.

FIG. 6 is an image diagram for describing operations of the region of interest deriving unit included in the region of interest image generating device.

FIG. 7 is an image diagram for describing operations of an image region of interest deriving unit included in the region of interest image generating device.

### DESCRIPTION OF EMBODIMENTS

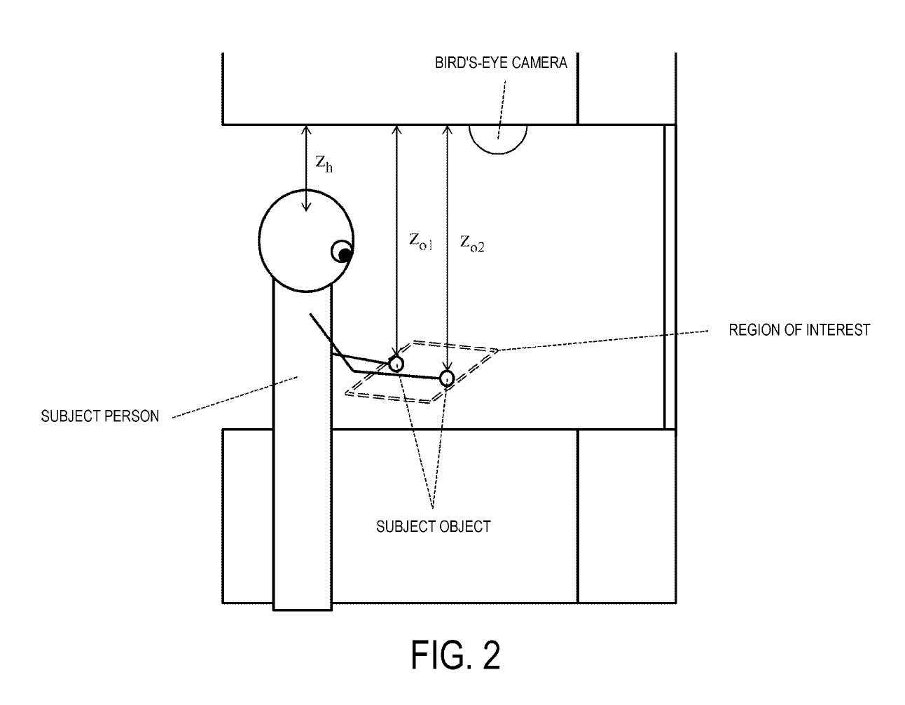

Before describing each component, an example of a photographing form assumed in the present embodiment is described. FIG. 2 is a diagram illustrating an example of a photographing form assumed in the present embodiment. FIG. 2 is merely an example, and the present embodiment is not limited to this photographing form. As illustrated in FIG. 2, the present embodiment assumes a photographing form in which the state of certain work is photographed in bird's-eye view by using an optical device such as a camera fixed in a place where the work is performed. Hereinafter, a camera for photographing the state of the work in bird's-eye view is referred to as a bird's-eye camera. However, it is assumed that a person who is performing the work (subject person) and an object interested by the person (subject object) are reflected in a bird's-eye camera image. In addition, it is assumed that height information of an object existing in the bird's-eye camera image can be detected. The height information will be described later. For example, as illustrated in FIG. 2, it is assumed that height information, i.e., a height zh of the head part of the subject person and heights zo1 and zo2 of the subject object can be detected. The heights are detected by using, for example, the position of the bird's-eye camera as a reference. In addition, in FIG. 2, a region surrounded by a double dashed line represents a region of interest. The region of interest will be described later.

The certain work assumed in the present embodiment may be any work as long as the subject person and the subject object can be photographed by using the bird's-eye camera and respective pieces of height information can be obtained. For example, the certain work may be cooking, medical treatment, or product assembly work.

### Region of Interest Image Generating Device 1

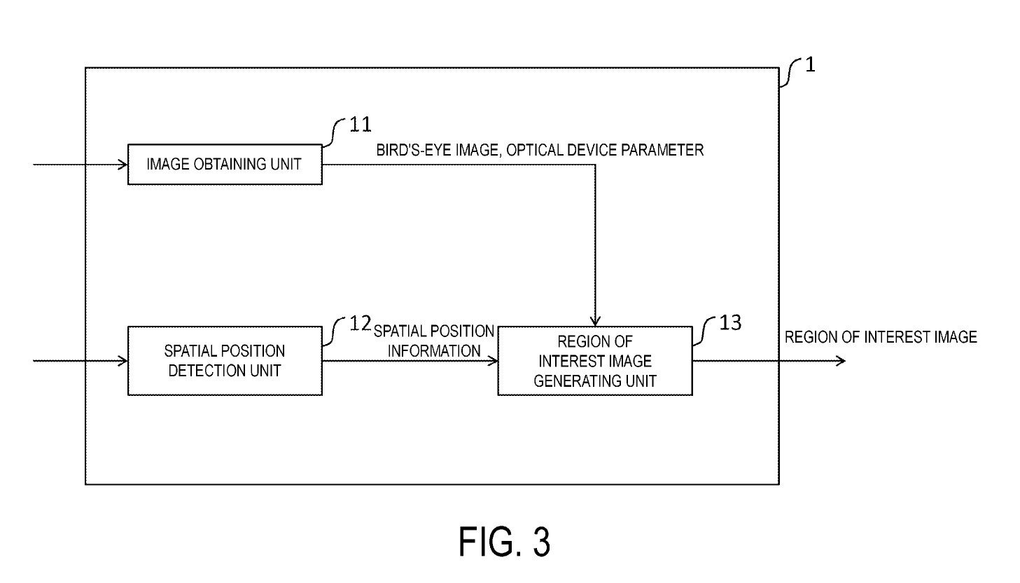

FIG. 3 is a block diagram illustrating a configuration example of a region of interest image generating device 1. As illustrated in FIG. 3, the region of interest image generating device 1 is generally a device that generates and outputs a region of interest image based on a bird's-eye image, parameters of an optical device that has photographed the bird's-eye image, and spatial position information. Note that, in the following description, a camera is used as an example of the optical device that has photographed the bird's-eye image. In addition, the parameters of the optical device are referred to as camera parameters. Here, the region of interest image is an image of a region to be interested (region of interest) in a space (space to be photographed) reflected in the bird's-eye image, as viewed from a real or virtual viewpoint. The region of interest image may be generated in real time concurrently with photographing the bird's-eye image, or after photographing the bird's-eye image is finished.

A configuration of the region of interest image generating device 1 is described by using FIG. 3. As illustrated in FIG. 3, the region of interest image generating device 1 is configured to include an image obtaining unit 11, a spatial position information obtaining unit 12, and a region of interest image generating unit 13.

The image obtaining unit 11 is configured to access an external image source (e.g., whole circumference bird's-eye camera installed on a ceiling) and supply an image to the region of interest image generating unit 13 as a bird's-eye image. In addition, the image obtaining unit 11 is configured to obtain camera parameters of the bird's-eye camera that has photographed the bird's-eye image, and supply the camera parameters to the region of interest image generating unit 13. Note that, in the present embodiment, it is assumed that there is one bird's-eye image for ease of description, but two or more bird's-eye images or a combination of a bird's-eye image and a different image may be used.

Hereinafter, it is assumed that at least a person (subject person) and an object of interest, which will be described later, are reflected in the bird's-eye image. Note that the subject person and the object of interest do not necessarily need to be reflected in one bird's-eye image, but may be reflected across multiple bird's-eye images. For example, in a case that a subject person is reflected in a bird's-eye image and an object of interest is reflected in a different image, the above-described condition may be satisfied by obtaining both of the images. However, in this case, relative positions of photographing devices that photograph the respective bird's-eye images need to be given.

Note that the bird's-eye image does not necessarily need to be an image itself photographed by the bird's-eye camera, but may be a corrected image obtained by making a correction based on lens characteristic information such that the distortion of the bird's-eye image is suppressed. Here, lens characteristics are information representing lens distortion characteristics of a lens attached to a camera that photographs the bird's-eye image. The lens characteristic information may be known distortion characteristics of a corresponding lens, may be distortion characteristics obtained by calibration, or may be distortion characteristics obtained by performing image processing, and the like of the bird's-eye image. Note that the lens distortion characteristics may include not only barrel distortion or pin-cushion distortion, but also distortion caused by a special lens such as a fish-eye lens.

Camera parameters are information representing characteristics of the bird's-eye camera that has photographed the bird's-eye image obtained by the image obtaining unit. For example, the camera parameters are the lens characteristics described above, a camera position and orientation, a camera resolution, and a pixel pitch. In addition, the camera parameters include pixel angle information. Here, the pixel angle information is three-dimensional angle information for a region obtained by dividing the bird's-eye image into regions with appropriate sizes, and the pixel angle information represents a direction in which the region is positioned when the camera that photographs the bird's-eye image is configured as an origin point. Note that the region, in the bird's-eye image, obtained by dividing the bird's-eye image into regions with appropriate sizes is, for example, a set of pixels constituting the bird's-eye image. A single pixel may constitute one region, or multiple pixels may constitute one region. The pixel angle information is calculated based on an input bird's-eye image and lens characteristics. In a case that a lens attached to the bird's-eye camera remains unchanged, a corresponding direction exists for each pixel of an image photographed by the camera. Although properties vary depending on a lenses or camera, for example, a pixel at the center of the photographed image corresponds to the vertical direction with respect to the lens of the bird's-eye camera. The pixel angle information is obtained by calculating, based on the lens characteristic information, a three-dimensional angle indicating a corresponding direction for each pixel in the bird's-eye image. Although processing using the above-described bird's-eye image or pixel angle information will be described below, the correction of the bird's-eye image or the deriving of pixel angle information may be performed first before supplying the bird's-eye image or the pixel angle information to the region of interest image generating unit 13, or may be performed in each component of the region of interest image generating unit 13 as necessary.

The spatial position detection unit 12 is configured to obtain one or more pieces of spatial position information of objects reflected in a bird's-eye image (subject object) in a space to be photographed, and supply the spatial position information to the region of interest image generating unit 13. The spatial position information of the subject objects includes at least height information of the subject object. The height information is coordinate information indicating the positions of the subject objects in the height direction in the space to be photographed. This coordinate information may be, for example, relative coordinates to a camera that photographs the bird's-eye image.

The subject object includes at least the head part of a subject person and both hands of the subject person. Here, the both hands of the subject person are used to determine a region of interest, and thus are also referred to as objects of interest. Examples of a method for obtaining the spatial position information may include a method for attaching a transmitter to the subject object and measuring a distance to a receiver arranged side by side with the transmitter in the vertical direction from the ground, or a method for obtaining the position of the subject object by means of an infrared sensor attached to the periphery of the subject object. In addition, the spatial position information may be a depth map derived by applying stereo matching processing to images photographed by multiple cameras. In this case, the above-described bird's-eye image may be included in the images photographed by the multiple cameras. The spatial position information is used, in a viewpoint position deriving unit 131 and a region of interest deriving unit 132 included in the region of interest image generating unit 13, which will be described later, to estimate at least the position of the head part of the subject person and the position of the objects of interest in the space to be photographed.

The region of interest image generating unit 13 is configured to generate and output an image of a region of interest as viewed from a viewpoint of the subject person in an input bird's-eye image, based on the input bird's-eye image and camera parameters, and input pieces of spatial position information of the respective subject objects. The details of the region of interest image generating unit 13 will be described below.

### Configuration of the Region of Interest Image Generating Unit 13

The region of interest image generating unit 13 included in the region of interest image generating device 1 is described. The region of interest image generating unit 13 is configured to generate and output a region of interest image based on an input bird's-eye image, camera parameters, and spatial position information.

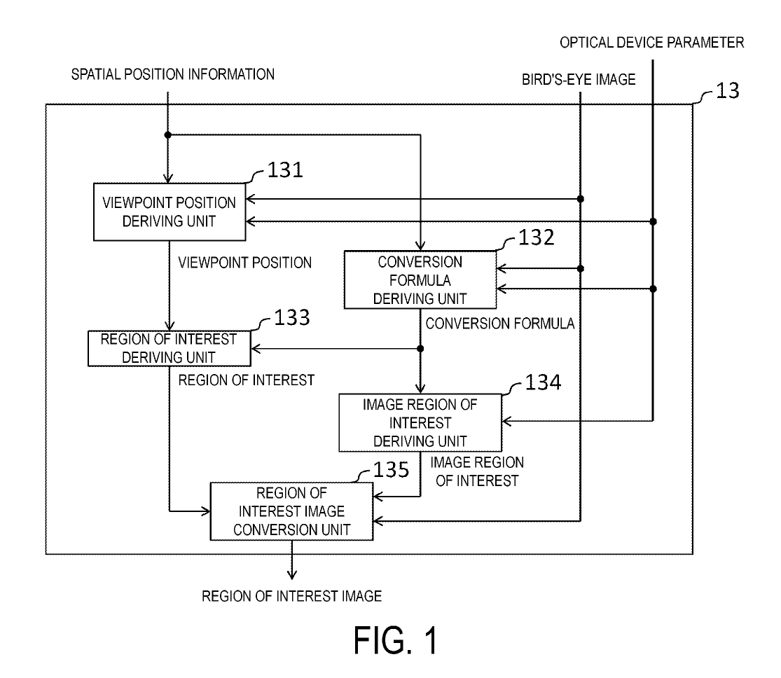

A configuration of the region of interest image generating unit 13 is described by using FIG. 1. FIG. 1 is a functional block diagram illustrating a configuration example of the region of interest image generating unit 13. As illustrated in FIG. 1, the region of interest image generating unit 13 is configured to include the viewpoint position deriving unit 131, the region of interest deriving unit 132, a conversion formula deriving unit 133, an image region of interest deriving unit 134, and a region of interest image conversion unit 135.

### Viewpoint Position Deriving Unit 131

The viewpoint position deriving unit 131 is configured to estimate a viewpoint position based on an input bird's-eye image and spatial position information and supply the viewpoint position to the conversion formula deriving unit 133. Here, the viewpoint position is information indicating, for example, the spatial position of the eyes of a subject person. A coordinate system for representing the viewpoint position is, for example, relative coordinates to a bird's-eye camera that photographs a bird's-eye image. Note that the coordinate system may be a different coordinate system as long as the spatial positional relationship between the eyes of the subject person and the bird's-eye camera can be recognized. One or more viewpoint positions are estimated for one subject person. For example, respective positions of both eyes may be configured as different viewpoint positions, or the intermediate position of both eyes may be used as a viewpoint position.

A procedure for estimating a viewpoint position in the viewpoint position deriving unit 131 is described. First, the viewpoint position deriving unit 131 detects at least an image region corresponding to the head part of a subject person based on an input bird's-eye image. The head part is detected by detecting, for example, characteristics of the human head part (e.g., ear, nose, mouth, and face outline). In addition, for example, in a case that a marker of which a relative position to the head part of the subject person is known is attached to the head part of the subject person, it is possible to detect the marker and detect the head part based on the marker. In this way, the viewpoint position deriving unit 131 detects the image region corresponding to the head part in the bird's-eye image.

Next, the viewpoint position deriving unit 131 estimates at least the spatial position and posture of the head part. Specifically, the following steps are performed. First, the viewpoint position deriving unit 131 extracts, from pixel angle information associated with the bird's-eye image, pixel angle information to which the image region corresponding to the head part corresponds. Next, the viewpoint position deriving unit 131 calculates the three-dimensional position of the image region corresponding to the head part based on information, included in input spatial position information, that represents the height of the head part, and the pixel angle information.

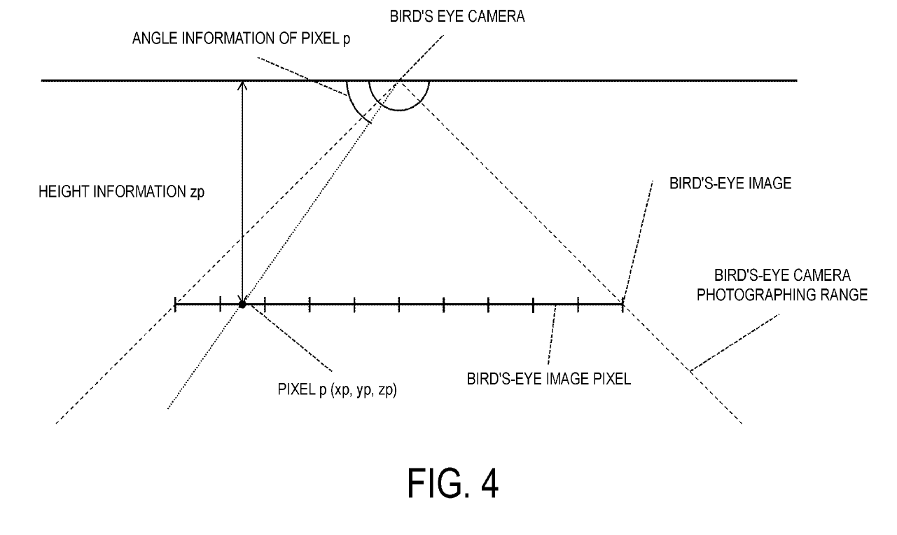

A method for obtaining, based on an image region corresponding to the head part in the bird's-eye image and pixel angle information corresponding to the image region, the three-dimensional position of the image region is described by using FIG. 4. FIG. 4 is a schematic diagram of a method for calculating, based on a pixel in the bird's-eye image and angle information of the pixel, a three-dimensional position to which the pixel corresponds. FIG. 4 is a horizontal view of a state in which the bird's-eye image is photographed by using a bird's-eye camera facing in the vertical direction. A plane existing within the photographing range of the bird's-eye camera represents the bird's-eye image, and the bird's-eye image is constituted of multiple bird's-eye image pixels. Here, although the sizes of the bird's-eye image pixels included in the bird's-eye image are the same for ease of description, the actual sizes of the bird's-eye image pixels are different depending on the positions of the bird's-eye image pixels with respect to the bird's-eye camera. In the bird's-eye image in FIG. 4, a pixel p in the figure represents the image region corresponding to the head part in the bird's-eye image. As illustrated in FIG. 4, the pixel p exists in a direction according to angle information, with respect to the position of the bird's-eye camera, corresponding to the pixel p. The three-dimensional position (xp, yp, zp) of the pixel p is calculated based on the height information zp of the pixel p and the angle information of the pixel p, which are included in spatial position information. This uniquely determines the three-dimensional position of the pixel p. A coordinate system for representing the three-dimensional position of the pixel p is, for example, relative coordinates to the bird's-eye camera that photographs the bird's-eye image.

In other words, regarding the three-dimensional position to which the pixel corresponds in the present embodiment, the position in the height direction is obtained based on the spatial position information, and the position in the horizontal direction, which is orthogonal to the height direction, is obtained based on the spatial position information, the pixel angle information, and the bird's-eye image.

The three-dimensional shape of the head part is obtained by performing similar processing for all or some of the pixels in the image region corresponding to the head part in the bird's-eye image. The shape of the head part is represented by, for example, the spatial positions of respective pixels corresponding to the head part, the spatial positions being represented by relative coordinates to the bird's-eye camera. In this way, the viewpoint position deriving unit 131 estimates the spatial position of the head part.

Next, by performing a similar procedure, for example, the viewpoint position deriving unit 131 detects spatial positions of characteristics (e.g., ear, nose, mouth, and face outline) of the human head part, and, for example, estimates a direction in which the face faces, i.e., the posture of the head part based on the positional relationship among the spatial positions.

Finally, the viewpoint position deriving unit 131 derives the spatial position of the eyes of the subject person based on the estimated spatial position and posture of the head part, and supplies the spatial position of the eyes to the conversion formula deriving unit 133 as a viewpoint position. The spatial position of the eyes is derived based on the estimated spatial position and posture of the head part, and the characteristics of the human head part and the spatial positions of the characteristics. For example, the position of the eyes may be derived by estimating the three-dimensional position of the face based on the spatial position and posture of the head part, and assuming that the eyes exist at a position closer to the top part of the head than the center of the face. In addition, for example, the position of the eyes may be derived based on the three-dimensional positions of ears, assuming that the eyes exist at a position spaced from the roots of the ears toward the face. In addition, for example, the position of the eyes may be derived based on the three-dimensional position of a nose or mouth, assuming that the eyes exist at a position spaced from the nose or mouth toward the top part of the head. In addition, for example, the position of the eyes may be derived based on the three-dimensional shape of the head part, assuming that the eyes exist at a position spaced from the center of the head part toward the face.

The viewpoint position deriving unit 131 outputs the position of the eyes derived as described above as a viewpoint position, and supplies the viewpoint position to the conversion formula deriving unit 133.

Note that the viewpoint position deriving unit 131 may not necessarily be configured to derive the position of the eyes of the subject person. That is, by estimating the three-dimensional position of an object other than the eyes of the subject person in the bird's-eye image, and assuming that the eyes virtually exist at the three-dimensional position of the object, an image as viewed from the three-dimensional position of the object may be configured as a region of interest image. For example, it is possible to place a marker within a range reflected in the bird's-eye image, and configure the position of the marker as a viewpoint position.

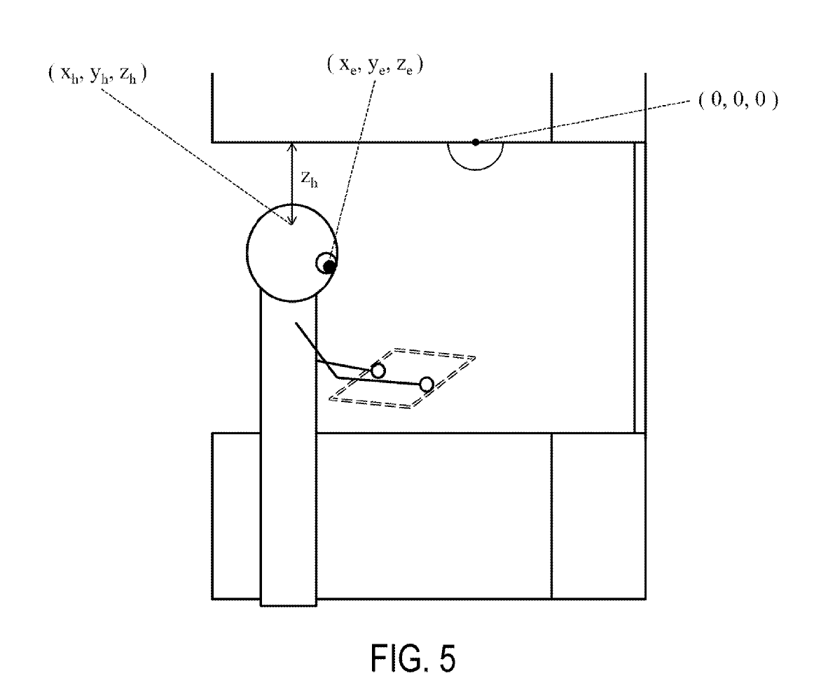

A procedure of processing by the viewpoint position deriving unit 131 is described by using FIG. 5. FIG. 5 is a diagram illustrating the correspondence relationship between the spatial positions of objects related to the deriving of viewpoint position. FIG. 5 is a diagram corresponding to FIG. 2, and the objects indicated in FIG. 5 are identical to the objects indicated in FIG. 2. That is, a bird's-eye camera, a subject person, a subject object, and a region of interest are indicated. First, the viewpoint position deriving unit 131 detects the head part of the subject person from a bird's-eye image. Next, the viewpoint position deriving unit 131 estimates the spatial position (xh, yh, zh) of the head part of the subject person based on the height information zh of the head part of the subject person and pixel angle information of a pixel corresponding to the head part of the subject person in the bird's-eye image. The spatial position is represented by a relative position to the position of the bird's-eye camera. That is, the coordinates of the bird's-eye camera are (0, 0, 0). Next, the viewpoint position deriving unit 131 estimates the spatial position (xe, ye, ze) of the eyes of the subject person based on the coordinates of the head part of the subject person. Finally, the viewpoint position deriving unit 131 configures the spatial position (xe, ye, ze) of the eyes of the subject person as a viewpoint position and outputs the viewpoint position.

### Region of Interest Deriving Unit 132

The region of interest deriving unit 132 is configured to derive a region of interest based on an input bird's-eye image and input spatial position information of respective subject objects, and supply the region of interest to the conversion formula deriving unit 133 and the image region of interest deriving unit 134. Here, the region of interest is information representing the position of a region interested by a subject person in a space. The region of interest is represented by, for example, a region with a prescribed shape (e.g., rectangle), existing in a space to be photographed, that is configured to surround an object of interest. The region of interest is, for example, represented and output as the spatial positions of respective vertices of a rectangle. As a coordinate system for this spatial position, for example, relative coordinates to a bird's-eye camera that photographs the bird's-eye image can be used.

Note that, it is desirable that the spatial positions representing the region of interest and a viewpoint position are represented by the same spatial coordinate system. That is, in a case that the viewpoint position described above is represented by a relative position to the bird's-eye camera, it is desirable that the region of interest is also represented by a relative position to the bird's-eye camera.

A procedure in which the region of interest deriving unit 132 estimates the region of interest is described. First, the region of interest deriving unit 132 detects one or more objects of interest from a bird's-eye image, and detects image regions corresponding to the objects of interest in the bird's-eye image. Here, the object of interest is an object serving as a clue for determining the region of interest, and is an object reflected in the bird's-eye image. For example, as described above, the object of interest may be a hand of a subject person performing a work, may be a tool being held by the subject person, or may be an object (work object) on which the subject person is working. In a case that there are multiple objects of interest in the bird's-eye image, image regions corresponding to the respective objects of interest are detected.

Next, the region of interest deriving unit 132 estimates the spatial position of the object of interest based on the image region corresponding to the object of interest in the bird's-eye image and the height information of the object of interest included in spatial position information. The spatial position of the object of interest is estimated in a method similar to the above-described estimation of the three-dimensional shape of the head part in the viewpoint position deriving unit 131. Similarly to the viewpoint position, the spatial position of the object of interest may be represented by relative coordinates to the bird's-eye camera. In a case that there are multiple objects of interest in the bird's-eye image, spatial positions corresponding to the respective objects of interest are estimated.

Next, the region of interest deriving unit 132 derives a plane of interest on which the region of interest exists. The plane of interest is configured, based on the spatial position of the object of interest, as a plane including the object of interest in a space to be photographed. For example, in the space of a region interested by the subject person, a plane, horizontal to the ground, that exists at a position intersecting the object of interest is configured as the plane of interest.

Next, the region of interest deriving unit 132 configures a region of interest on the plane of interest. The region of interest is configured based on the plane of interest and the spatial position of the object of interest. For example, the region of interest is configured as a region, having a prescribed shape (e.g., rectangle), that exists on the plane of interest. The region of interest includes some or all of the objects of interest existing on the plane of interest, in which some or all of the objects of interest are inscribed. The region of interest is, for example, represented and output as the spatial positions of respective vertices of the prescribed shape (e.g., rectangle).

For example, in a case that the objects of interest are left and right hands of the subject person, the plane of interest is a horizontal plane existing at a position intersecting the hands of the subject person. In addition, the region of interest is a region, having the prescribed shape, that is arranged on the plane of interest. The region of interest includes the left and right hands of the subject person existing on the plane of interest, in which the left and right hands of the subject person are inscribed. A coordinate system used to represent the region of interest may be, for example, relative coordinates to the bird's-eye camera. In addition, it is desirable that this coordinate system is the same as the coordinate system of the viewpoint position.

Finally, the region of interest deriving unit 132 supplies the region of interest to the conversion formula deriving unit 133 and the image region of interest deriving unit 134.

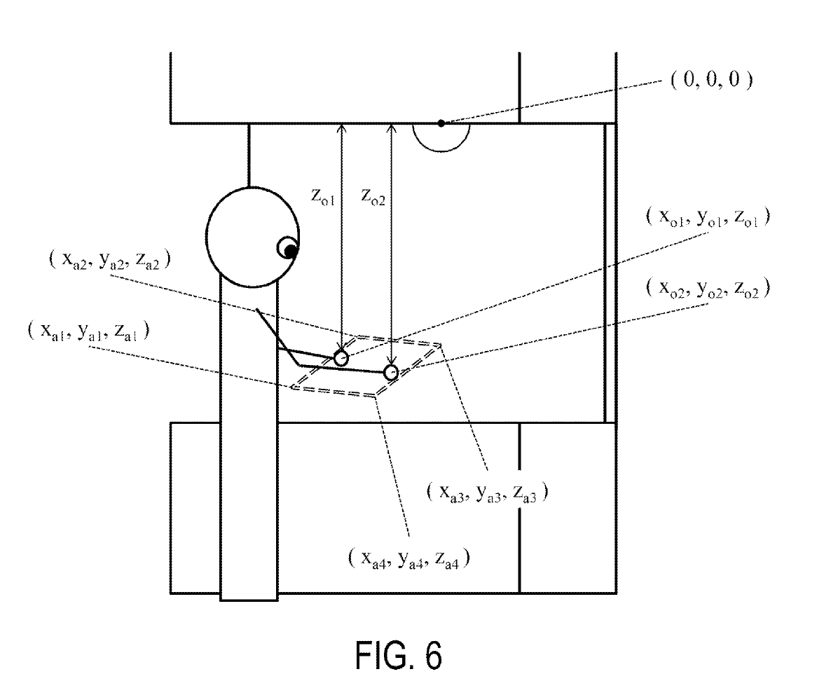

A procedure for processing by the region of interest deriving unit 132 are described by using FIG. 6. FIG. 6 is a diagram illustrating an example of the correspondence relationship between coordinates related to the deriving of a region of interest. Note that, here, a case that two objects of interest exist is described as an example. In addition, the region of interest is represented by a rectangle. Similarly to FIG. 5, FIG. 6 is a diagram corresponding to FIG. 2, and the objects indicated in FIG. 6 are identical to the objects indicated in FIG. 2. First, the region of interest deriving unit 132 detects objects of interest from a bird's-eye image. Next, the region of interest deriving unit 132 estimates the spatial positions (xo1, yo1, zo1) and (xo2, yo2, zo2) of the objects of interest from height information zo1 and zo2, and pixel angle information of pixels corresponding to the objects of interest. Each of the spatial positions is represented by a relative position to the position of the bird's-eye camera. That is, the coordinates of the bird's-eye camera are (0, 0, 0). Next, the region of interest deriving unit 132 configures a plane of interest from the spatial positions of the objects of interest. The plane of interest is, for example, a plane intersecting the spatial positions (xo1, yo1, zo1) and (xo2, yo2, zo2) of the objects of interest. Next, the region of interest deriving unit 132 configures a region of interest existing in the plane of interest based on the spatial positions of the objects of interest and the plane of interest. That is, the region of interest deriving unit 132 configures a region of interest, having a rectangle shape, that exists on the plane of interest and that surrounds the spatial positions (xo1, yo1, zo1) and (xo2, yo2, zo2) of the objects of interest. The region of interest deriving unit 132 outputs the coordinates (xa1, ya1, za1), (xa2, ya2, za2), (xa3, ya3, za3), and (xa4, ya4, za4) of the vertices of the rectangle as a region of interest. Coordinates representing the region of interest are represented by relative coordinates to the position of the bird's-eye camera, similarly to the case of the positions of the object of interests.

### Conversion Formula Deriving Unit 133

The conversion formula deriving unit 133 is configured to derive a formula for moving a viewpoint from the bird's-eye camera to a virtual viewpoint based on the input viewpoint position and region of interest, and supply the formula to the region of interest image conversion unit 135.

The conversion formula deriving unit 133 is configured to calculate the relative positional relationship among the bird's-eye camera, the region of interest, and the viewpoint based on the viewpoint position and the region of interest, and obtain a formula for converting the bird's-eye image (an image as viewed from the bird's-eye camera) to a virtual viewpoint image (an image as viewed from the supplied viewpoint position). In other words, this conversion is a conversion for representing the movement of the observation viewpoint of the region of interest from the position of the bird's-eye camera viewpoint to the position of the virtual viewpoint. For this conversion, for example, projection transformation, affine transformation, or pseudo-affine transformation can be used.

### Image Region of Interest Deriving Unit 134

The image region of interest deriving unit 134 is configured to calculate an image region of interest based on an input region of interest, bird's-eye image, and camera parameters, and supply the image region of interest to the region of interest image conversion unit 135. Here, the image region of interest is information indicating an image region on the bird's-eye image corresponding to the region of interest in a space to be photographed. For example, the image region of interest is information representing, as a binary, whether each pixel constituting the bird's-eye image is included in the image region of interest.

A procedure in which the image region of interest deriving unit 134 derives an image region of interest are described below. First, the image region of interest deriving unit 134 converts the representation of an input region of interest to the representation thereof in a relative coordinate system to the bird's-eye camera. As described above, in a case that the spatial positions of respective vertices of a rectangle representing the region of interest are represented by relative coordinates to the bird's-eye camera, the information of the spatial positions can be used as it is. In addition, in a case that the region of interest is represented by the absolute coordinates thereof in a space to be photographed reflected in the bird's-eye image, the relative coordinates can be derived by calculating a difference between the absolute coordinates of the region of interest and the absolute coordinates of the position of the bird's-eye camera.

Next, based on the above-described region of interest represented by relative coordinates, and camera parameters, the image region of interest deriving unit 134 calculates an image region on the bird's-eye image corresponding to the region of interest, and configure the image region as an image region of interest. Specifically, the image region of interest deriving unit 134 obtains the image region of interest by calculating pixels, in the bird's-eye image, to which respective points in the region of interest correspond. The image region of interest deriving unit 134 supplies the image region of interest calculated as described above to the region of interest image conversion unit 135 together with the bird's-eye image.

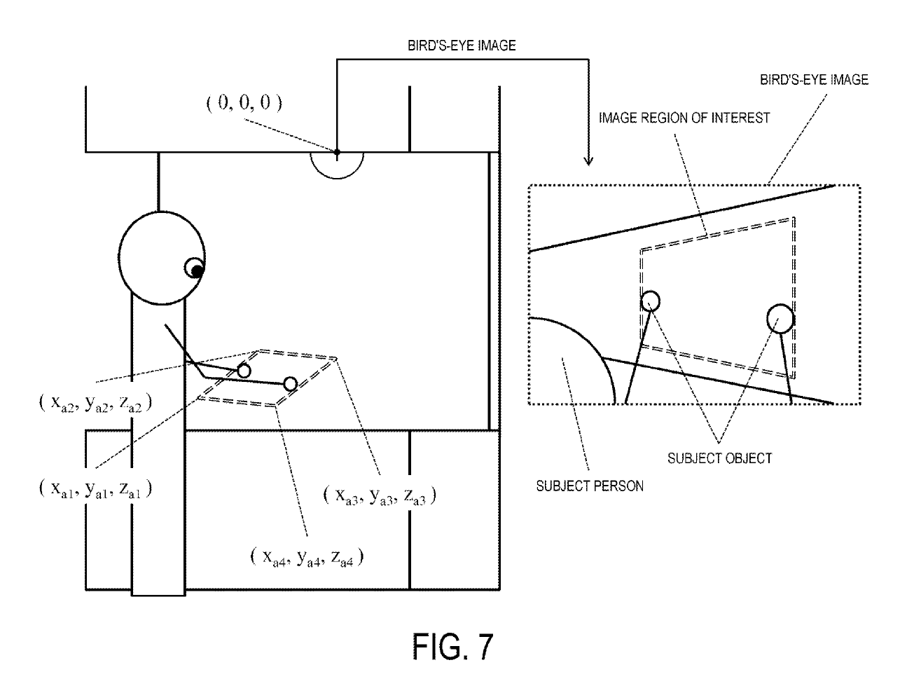

A procedure of processing by the image region of interest deriving unit 134 is described by using FIG. 7. FIG. 7 is a diagram illustrating the correspondence relationship between coordinates related to the deriving of an image region of interest, and an example of the image region of interest. Similarly to FIG. 5, the left side of FIG. 7 is a diagram corresponding to FIG. 2, and the objects indicated in the left side of FIG. 7 are identical to the objects indicated in FIG. 2. The region surrounded by the dashed line on the right side of FIG. 7 represents a bird's-eye image photographed by the bird's-eye camera in FIG. 7. In addition, the region surrounded by the double dashed line in the bird's-eye image represents a region of interest. Note that, for the simplification of the diagram, in FIG. 7, an image obtained by clipping a part of the bird's-eye image is used as the bird's-eye image. First, a spatial pixel of interest deriving unit 133 calculates an image region, in the bird's-eye image, that corresponds to the region of interest, based on the coordinates (xa1, ya1, za1), (xa2, ya2, za2), (xa3, ya3, za3), and (xa4, ya4, za4) of the region of interest and the relative distance from the region of interest to the bird's-eye camera that are derived by the region of interest deriving unit 132, and camera parameters specific to the camera that photographs the bird's-eye image. The image region of interest deriving unit 134 outputs, as an image region of interest, information representing the image region in the bird's-eye image, for example, coordinate information of a pixel corresponding to the image region.

### Region of Interest Image Conversion Unit 135

The region of interest image conversion unit 135 is configured to calculate and output a region of interest image based on the input bird's-eye image, conversion formula, and image region of interest. The region of interest image is used as an output of the region of interest image generating unit 13.

The region of interest image conversion unit 135 is configured to calculate the region of interest image based on the bird's-eye image, the conversion formula, and the image region of interest. That is, the region of interest image conversion unit 135 converts, by means of the conversion formula obtained as described above, the image region of interest in the bird's-eye image to generate an image corresponding to a region of interest as viewed from a virtual viewpoint, and outputs the image as the region of interest image.

### Processing Order of the Region of Interest Image Generating Unit 13

Processing performed by the region of interest image generating unit 13 is summarized as follows.

First, the region of interest image generating unit 13 estimates the spatial position (xh, yh, zh) of the head part of a subject person based on a bird's-eye image and the height information zh of the subject person, and calculates a viewpoint position (xe, ye, ze) based on the spatial position (xh, yh, zh). Next, the region of interest image generating unit 13 estimates the spatial position (xo, yo, zo) of the object of interest based on the bird's-eye image and the height information zo of an object of interest. Next, the region of interest image generating unit 13 configures, based on the spatial position of the object of interest, the spatial positions (xa1, ya1, za1), (xa2, ya2, za2), (xa3, ya3, za3), and (xa4, ya4, za4) of four vertices of a rectangle representing a region of interest. Next, the region of interest image generating unit 13 configures a viewpoint movement conversion formula corresponding to processing for moving a viewpoint with respect to the region of interest from a bird's-eye camera position (0, 0, 0) to the viewpoint position (xe, ye, ze) of the subject person, based on the relative positional relationship among the viewpoint position (xe, ye, ze), the region of interest (xa1, ya1, za1), (xa2, ya2, za2), (xa3, ya3, za3), and (xa4, ya4, za4), and the bird's-eye camera position (0, 0, 0). Next, the region of interest image generating unit 13 calculates an image region of interest on the bird's-eye image based on camera parameters and the region of interest. Finally, the region of interest image generating unit 13 applies the conversion by means of the viewpoint movement conversion formula to the image region of interest to obtain a region of interest image, and outputs the region of interest image.

Note that the processing for estimating the viewpoint position from the bird's-eye image and the processing from estimating the region of interest from the bird's-eye image to calculating the image region of interest may not necessarily be performed in the above-described order. For example, the estimation of the region of interest and the calculation of the image region of interest may be performed before the processing for estimating the viewpoint position or the deriving of the conversion formula.

### Effects of the Region of Interest Image Generating Unit 13

The region of interest image generating unit 13 described above is configured to include a function of estimating, based on an input bird's-eye image and camera parameters, the position of the eyes of a person and the position of an object of interest in an image, configuring, based on these positions, a conversion formula for moving a viewpoint position from a bird's-eye camera viewpoint to a virtual viewpoint, and generating a region of interest image by using the conversion formula.

Thus, compared with a method for estimating an interested region by using a special tool such as a known eye-tracking device, it becomes possible to generate a region of interest image corresponding to a region of interest as viewed from a subject person without using the special tool, and the like.

### Supplemental Note 1

In the above description of the region of interest image generating device 1, the spatial position detection unit 12 may configure, as spatial position information, a depth map derived by applying stereo matching processing to images photographed by multiple cameras. In a case that the depth map obtained by using the images photographed by the multiple cameras are configured as spatial position information, it is possible to input the multiple images to the viewpoint position deriving unit 131 as bird's-eye images, and use these images to derive a viewpoint position. Similarly, it is possible to input the multiple images to the region of interest deriving unit 132 as bird's-eye images, and use these images to derive a region of interest. However, in this case, it is assumed that the relative positions between a bird's-eye camera and the multiple cameras that photograph the images are known.

### Supplemental Note 2

In the above description of the region of interest image generating device 1, an example in which the viewpoint position deriving unit 131 is configured to derive a viewpoint position based on a bird's-eye image is described, but this bird's-eye image may be frames constituting a video. In this case, a viewpoint position may not necessarily be derived for each frame. For example, in a case that a viewpoint position cannot be derived for a current frame, it is possible to configure a viewpoint position derived for a frame before or after the current frame as the viewpoint position of the current frame. In addition, for example, it is possible to temporally divide a bird's-eye image, and configure a viewpoint position derived for one frame (reference frame) included in one duration as a viewpoint position for all frames included in the duration. In addition, for example, it is possible to derive viewpoint positions for all frames in the duration, and configure, for example, the average value of the viewpoint positions as a viewpoint position to be used in the duration. Note that the duration is a set of contiguous frames in the bird's-eye image, and the duration may be one frame in the bird's-eye image or may be all frames in the bird's-eye image.

Examples of a method for determining a frame to be used as a reference frame in one duration obtained by temporally dividing the bird's-eye image may include a method in which the frame is selectable manually after photographing of the bird's-eye image is finished, or a method in which the frame is determined based on the gesture, operation, and voice of a subject person while photographing the bird's-eye image. In addition, for example, it is possible to automatically identify a distinctive frame in the bird's-eye image (a frame in which a significant movement occurs or the number of objects of interest increases or decreases), and configure the frame as a reference frame.

Note that, although the deriving of a viewpoint position in the viewpoint position deriving unit 131 is described above, the same applies to the deriving of a region of interest in the region of interest deriving unit 132. That is, in a case that the bird's-eye image includes frames constituting a video, a region of interest may not necessarily be derived for each frame. For example, in a case that a region of interest cannot be derived for a current frame, it is possible to configure a region of interest derived for a frame before or after the current frame as the region of interest of the current frame. In addition, for example, it is possible to temporally divide a bird's-eye image, and configure a region of interest derived for one frame (reference frame) included in one duration as a region of interest for all frames included in the duration. Similarly, it is possible to derive regions of interest for all frames in the duration, and configure, for example, the average value of the regions of interest as a region of interest to be used in the duration.

### Supplemental Note 3

In the above description of the region of interest image generating device 1, it is described that in the space of a region interested by a subject person, a plane, horizontal to the ground, that exists at a position intersecting an object of interest is configured as a plane of interest. However, the plane of interest may not necessarily be configured as described above.

For example, the plane of interest may be a plane positioned away from a position intersecting an object of interest in the height direction. In this case, the plane of interest may not necessarily intersect the object of interest. In addition, for example, in a case that there are multiple objects of interest, the plane of interest may be a plane existing at a height position at which the multiple objects of interest exist in common, or may be a plane existing at an intermediate height among the heights of the multiple objects of interest (e.g., an average value of the heights).

In addition, the plane of interest may not necessarily be configured as a plane horizontal to the ground. For example, in a case that an object of interest includes a flat plane, the plane of interest may be configured as a plane along the flat plane. In addition, for example, the plane of interest may be configured as a plane inclined, with a selected angle, to a direction toward the subject person. In addition, for example, when an object of interest is viewed from a viewpoint position, the plane of interest may be configured as a plane that has an angle orthogonal to the direction of a line of sight from the viewpoint position. However, in this case, the viewpoint position deriving unit 131 needs to supply the output viewpoint position to the region of interest deriving unit 132.

### Supplemental Note 4

In the above description of the region of interest image generating device 1, it is described that the region of interest is configured as a region, having a prescribed shape, that exists on a plane of interest. The region of interest includes some or all of the objects of interest existing on the plane of interest, in which some or all of the objects of interest are inscribed. However, the region of interest may not necessarily be configured in this way.

Some or all of the objects of interest may not necessarily be inscribed in the region of interest. For example, the region of interest may be expanded or reduced based on a region in which some or all of the objects of interest are inscribed. As a result of reducing the region of interest as described above, the objects of interest may not be included in the region of interest.

In addition, the region of interest may be configured as a region centered at the position of an object of interest. That is, the region of interest may be configured such that the object of interest is positioned at the center of the region of interest. In this case, the size of the region of interest may be configured to be any size, or may be configured to be a size such that other objects of interest are included in the region of interest.

In addition, the region of interest may be configured based on a selected region. For example, in a case that the above-described place where certain work is performed is divided into appropriate regions (divided regions), a divided region in which an object of interest exists may be configured as a region of interest. In the case of a kitchen, the divided region is, for example, a sink, a stove, or a countertop. It is assumed that the divided region is represented by a prescribed shape (e.g., rectangle). However, it is assumed that the position of the divided region is known. That is, it is assumed that the positions of respective vertices of the prescribed shape representing the divided region are known. A coordinate system for representing the position of the divided region is, for example, relative coordinates to a bird's-eye camera that photographs a bird's-eye image. The above-described divided region in which an object of interest exists (divided region of interest) is determined by comparing horizontal coordinates of the object of interest and the divided region. That is, in a case that the horizontal coordinates of the object of interest are included in a region surrounded by the horizontal coordinates of the vertices of the prescribed shape representing the divided region, it is determined that the object of interest exists in the divided region. Note that, vertical coordinates may be used in addition to the horizontal coordinates. For example, even in a case that the above-described condition is satisfied, it may be determined that the object of interest does not exist in the divided region. Such a decision may be made in a case that the vertical coordinates of the vertices of the prescribed shape representing the divided region are significantly different from the vertical coordinates of the object of interest.

A procedure for configuring a region of interest based on the position of a divided region. First, similarly to the above-described method, a plane of interest is configured based on the position of an object of interest. Next, as described above, a divided region in which the object of interest exists is determined. Next, points at which straight lines, extending in the height direction from vertices of a prescribed shape that represents the divided region of interest, intersect the plane of interest are calculated. Finally, the points intersecting the plane of interest are configured as a region of interest.

### Supplemental Note 5

In the above description of the region of interest image generating device 1, it is described that an example of a prescribed shape representing a region of interest is a rectangle, but the prescribed shape may not necessarily be a rectangle. For example, the prescribed shape may be a polygon other than a rectangle. In this case, the coordinates of all vertices of the polygon are configured as a region of interest. In addition, for example, the prescribed shape may be a shape obtained by distorting the sides of the polygon. In this case, assuming that the shape is represented by a set of points, the coordinates of the points are configured as a region of interest. The same applies to the prescribed shape representing a divided region described in the section of supplemental note 4.

### Modification 1

In the above description of the region of interest image generating device 1, it is described that spatial position information, a bird's-eye image, and camera parameters are added to the viewpoint position estimating unit 131, but user information may further be input. Here, the user information is information assisting the deriving of a viewpoint position, for example, information including information, associated with a user, that represents the position of eyes with respect to the shape of the head part. In this case, the viewpoint position estimating unit 131 is configured to identify a subject person in a bird's-eye image, and receive information related to the identified subject person from the user information. In addition, the viewpoint position estimating unit 131 is configured to derive the position of the eyes of the subject person based on the estimated three-dimensional shape of the head part and this user information, and configure the position of the eyes as a viewpoint position. As described above, by using the user information to derive a viewpoint position, it is possible to derive the three-dimensional position of the eyes more accurately, and it is possible to derive a viewpoint position more accurately.

### Modification 2

In the above description of the region of interest image generating device 1, it is described that the viewpoint position deriving unit 131 is configured to derive a viewpoint position based on spatial position information including at least height information, a bird's-eye image, and camera parameters. However, in a case that the viewpoint position is determined by using only the spatial position information, the bird's-eye image and the camera parameters may not necessarily be input to the viewpoint position deriving unit 131. That is, in a case that three-dimensional coordinate information is included in addition to the height information in the spatial position information representing the position of the head part of the subject person, it is possible to estimate the position of the eyes from the position of the head part of the subject person and derive a viewpoint position without using the bird's-eye image and the camera parameters.

In addition, the same applies to the deriving of a region of interest in the region of interest deriving unit 132. In the above description, it is described that the region of interest deriving unit 132 is configured to estimate the position of an object of interest based on spatial position information including at least height information, a bird's-eye image, and camera parameters, and derive a region of interest based on the position of the object of interest. However, in a case that the position of the object of interest is determined by using only the spatial position information, the bird's-eye image and the camera parameters may not necessarily be input to the region of interest deriving unit 132. That is, in a case that three-dimensional coordinate information is included in addition to the height information in the spatial position information representing the position of the object of interest, the coordinates may be configured as coordinates representing the position of the object of interest without using the bird's-eye image and the camera parameters.

### Modification 3

In the above description of the region of interest image generating device 1, it is described that the viewpoint position deriving unit 131 is configured to estimate the spatial position of the head part of the subject person based on spatial position information including at least height information, a bird's-eye image, and camera parameters, estimate the position of the eyes of the subject person from the spatial position of the head part of the subject person, and configure the position of the eyes of the subject person as a viewpoint position. However, the viewpoint position may not necessarily be derived in the above-described method.

For example, it is possible to configure preconfigured three-dimensional spatial coordinates (viewpoint candidate coordinates) serving as candidates for a viewpoint position, and configure viewpoint candidate coordinates at a position closest to the head part of a subject person as the viewpoint position. Coordinates representing the viewpoint candidate coordinates may be, for example, relative coordinates to a camera that photographs a bird's-eye image. In a case that the viewpoint position is derived in this way, it is assumed that the viewpoint candidate coordinates are input to the region of interest image generating unit 13 and supplied to the viewpoint position deriving unit 131.

A method for configuring viewpoint candidate coordinates is described below. The horizontal coordinates (a coordinate system orthogonal to height information) of the viewpoint candidate coordinates may be configured, for example, as a position from which the divided region is looked down from the front for each of the above-described divided regions. Alternatively, the horizontal coordinates may be any position selectively configured. The vertical coordinates (height information) of the viewpoint candidate coordinates may be configured, for example, as a position, estimated based on the height of the subject person, at which the eyes of the subject person are considered to exist, or may be configured as a position at the average height of the eyes of humans. Alternatively, the horizontal coordinates may be any position selectively configured.

Among the viewpoint candidate coordinates configured as described above, viewpoint candidate coordinates at a position closest to the head part of the subject person are configured as a viewpoint position. Note that in a case that a viewpoint position is derived by using viewpoint candidate coordinates, both of horizontal coordinates and vertical coordinates of the viewpoint candidate coordinates may not necessarily be used. That is, it is possible to configure the horizontal coordinates of the viewpoint position by using the viewpoint candidate coordinates, and configure the vertical coordinates of the viewpoint position by estimating the spatial position of the head part of the subject person as described above. Similarly, it is possible to configure the vertical coordinates of the viewpoint position by using the viewpoint candidate coordinates, and configure the horizontal coordinates of the viewpoint position by estimating the spatial position of the head part of the subject person as described above.

In addition, for example, a point at a certain position with respect to a region of interest may be configured as a viewpoint position. That is, it is possible to assume that a viewpoint exists at a position in a prescribed distance from a region of interest and at a prescribed angle with respect to the region of interest, and configure the position as a viewpoint position. However, in this case, the region of interest deriving unit 132 needs to supply the output region of interest to the viewpoint deriving unit 131. In addition, in this case, a bird's-eye image and camera parameters may not necessarily be input to the viewpoint deriving unit 131.

In addition, it is possible to predetermine the position of a viewpoint, and configure the position as a viewpoint position. In this case, the region of interest image generating unit 13 may not necessarily be configured to include the viewpoint position deriving unit 131. However, in that case, it is assumed that the viewpoint position is supplied to the region of interest image generating unit 13.

### Modification 4

In the above description of the region of interest image generating device 1, it is described that a viewpoint position is output from the viewpoint position deriving unit 131, but in addition to this, the viewpoint position deriving unit 131 may be configured to include a function for issuing a notification in a case that the viewpoint position cannot be derived. For example, the function for issuing a notification may be a voice announcement, may be an alarm voice, or may be the flicker of a lamp.

The above description also applies to the region of interest deriving unit 132. That is, the region of interest deriving unit 132 may be configured to include a function as described above for issuing a notification in a case that the viewpoint position cannot be derived.

### INDUSTRIAL APPLICABILITY

### Implementation Examples by Software

The region of interest image generating device 1 may be achieved with a logic circuit (hardware) formed as an integrated circuit (IC chip) or the like, or with software using a Central Processing Unit (CPU).

In the latter case, the region of interest image generating device 1 includes a CPU configured to perform commands of a program being software for achieving the functions, a Read Only Memory (ROM) or a storage device (these are referred to as “recording medium”) in which the program and various kinds of data are recorded in a computer- (or CPU-) readable manner, and a Random Access Memory (RAM) in which the program is loaded. The computer (or CPU) reads from the recording medium and performs the program to achieve the object of one aspect of disclosure. As the above-described recording medium, a “non-transitory tangible medium” such as a tape, a disk, a card, a semiconductor memory, and a programmable logic circuit can be used. The above-described program may be supplied to the above-described computer via a transmission medium (such as a communication network and a broadcast wave) capable of transmitting the program. Note that one aspect of disclosure may also be implemented in a form of a data signal embedded in a carrier in which the program is embodied by electronic transmission.

### CROSS-REFERENCE OF RELATED APPLICATION

This application claims priority based on JP 2016-090463 filed in Japan on Apr. 28, 2016, the contents of which are incorporated herein by reference.

### REFERENCE SIGNS LIST

1 Region of interest image generating device
11 Image obtaining unit
12 Spatial position detection unit
13 Region of interest image generating unit
131 Viewpoint position deriving unit
132 Region of interest deriving unit
133 Conversion formula deriving unit
134 Image region of interest deriving unit
135 Region of interest image conversion unit

1. An image generating device that extracts, from at least one bird's-eye image, a region of interest being an interested region in the bird's-eye image as a region of interest image as viewed from a different viewpoint, the image generating device comprising:
a viewpoint position deriving unit configured to derive a viewpoint position based on at least the at least one bird's-eye image, parameters related to an optical device for photographing the bird's-eye image, and spatial position information for indicating a spatial position of an object in the at least one bird's-eye image;
a region of interest deriving unit configured to derive the region of interest based on at least the at least one bird's-eye image, the parameters, and the spatial position information;
a conversion formula deriving unit configured to derive, based on at least the viewpoint position and the region of interest, a conversion formula for converting a first image, in the at least one bird's-eye image, that corresponds to the region of interest to an image as viewed from the viewpoint position;
an image region of interest deriving unit configured to derive, based on at least the at least one bird's-eye image, the parameters, and the region of interest, an image region of interest being a region, in the at least one bird's-eye image, that corresponds to the region of interest; and
a region of interest image conversion unit configured to extract a pixel corresponding to the image region of interest from the at least one bird's-eye image based on at least the conversion formula, the at least one bird's-eye image, and the image region of interest, and converts the pixel to the region of interest image.

2. The image generating device according to claim 1, wherein
the spatial position information includes height information related to a person in the at least one bird's-eye image, and
the viewpoint position deriving unit is configured to derive the viewpoint position based on at least the height information related to the person and the at least one bird's-eye image.

3. The image generating device according to claim 1, wherein
the spatial position information includes height information related to an interested subject in the at least one bird's-eye image, and
the region of interest deriving unit is configured to derive the region of interest based on at least the height information related to the subject and the at least one bird's-eye image.

4. The image generating device according to claim 3, wherein
the subject is a hand of a person.

5. The image generating device according to claim 3, wherein
the subject is a device handled by a person.
